(19) United States
(12) Patent Application Publication
(10) Pub. No.: US 2006/0190695 A1
(43) Pub. Date: Aug. 24, 2006

(54) Method and system for controlling access in memory devices, computer program product therefor

(75) Inventor: Nicolas Bernard Grossier, Oreno di Vimercate (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 11/344,537

(22) Filed: Jan. 30, 2006

(30) Foreign Application Priority Data
Jan. 31, 2005 (EP) 05001918.1

(51) Int. Cl. G06F 12/14

(52) U.S. Cl. 711/163

(57) ABSTRACT

A system for providing controlled access to a memory area storing code and data, includes a processor cooperating with the memory area. The processor is configured for marking the instructions processed with a field describing the origin of the code being executed, and enabling data access in the memory area only from authorized code. Typically, the processor includes a pipeline emulation block, and the controlled access to said memory area is implemented via the pipeline emulation block. The processor may be a RISC processor, such as an ARM processor, configured for associating with the instructions currently in the pipeline a bit marking if the instruction in question has been executed from an authorized memory area or not.

### BACKGROUND OF THE INVENTION

1. Field of the Invention

The invention relates to techniques for controlling access in memory devices.

The invention was developed by paying specific attention to the possible application in processors, such as ARM7TDMI processors, and similar microprocessors with regular pipeline.

2. Description of the Related Art

The data and the code stored in the memory area of a microprocessor may contain significant and/or proprietary information related to the know-how of the user (customer). Additionally, modifications in the code/data stored in a microprocessor may reduce the reliability of the whole system and/or introduce mismatch with the initial functionality of the microprocessor.

As a consequence of this, the code and the data stored in a microprocessor need protection against intrusion and undesired alteration. Several applications may thus require that access to critical data or code stored in the memory area of a microprocessor is properly controlled.

A typical way of implementing controlled access to critical memory area is to use a memory management unit (MMU) with the ensuing possibility of marking certain areas in order to prevent unwanted access to those areas. This approach to controlled access implementation requires, in general, a significant amount of hardware.

FIG. 1 shows an exemplary system overview wherein a debugger block 10 directly communicates with a microprocessor 20. The microprocessor 20 can be, e.g., a processor of the ST30 family. The microprocessor 20 is connected, via a system bus 30, to a working memory 40, to a trusted code memory 50 and to a sensible data/code memory 60. Specifically, the working memory 40 can be a random access memory (RAM) device, and the two memory areas 50 and 60 can be portions of a flash memory device. The working memory 40 directly communicates with a monitor/boot block 70. The debugger block 10 and the monitor/boot block 70 are element of an “external” world 80 with respect to an “internal” world 90 containing the microprocessor 20.

Starting from the arrangement of FIG. 1, a dedicated design without external access can be achieved, for instance, by disabling communication between the external world 80 and the internal world 90.

FIG. 2 shows an example of controlled access that employs a memory management unit (MMU) 100. In FIG. 2 the blocks that are identical or equivalent to those already described with reference to FIG. 1 are designated with the same reference numbers. In the arrangement of FIG. 2 the memory management unit 100 is added to the microprocessor 20 with the aim of maintaining communications among the microprocessor 20 and the memory blocks 40, 50 and 60. Specifically, the memory management unit 100 provides a privileged mode. This solution is expensive in term of area consumption.

The possibility also exists of “mixing” the solutions discussed in the foregoing, by disabling the communication between the external world 80 and the internal world 90 while also including the memory management unit 100 in the resulting arrangement.

### BRIEF SUMMARY OF THE INVENTION

While such prior art arrangements are per se capable of providing satisfactory results, the need is felt for an improved solution adapted to ensure a minimum amount of additional hardware for controlling access in memory devices.

One embodiment of the invention provides such an improved solution.

One embodiment of the present invention provides a method having the features set forth in the claims that follow. The invention also relates to a corresponding system as well as a related computer program product, loadable in the memory of at least one computer and including software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Reference to “at least one computer” is evidently intended to highlight the possibility for the present invention to be implemented in a distributed/ modular fashion.

The claims are an integral part of the disclosure of the invention provided herein.

### BRIEF DESCRIPTION OF THE SEVERAL VIEWS OF THE DRAWINGS

The invention will now be described, by way of example only, with reference to the enclosed figures of drawing, wherein:

FIGS. 1 and 2, related to the prior art, have already been described in the foregoing;

FIG. 3 shows an example of controlled access according to the solution described herein;

FIG. 4 shows an example of protection architecture according to the solution described herein;

FIG. 5 shows an example of timing diagram according to the solution described herein; and

FIG. 6 shows an example of additional protection hardware according to the solution described herein.

### DETAILED DESCRIPTION OF THE INVENTION

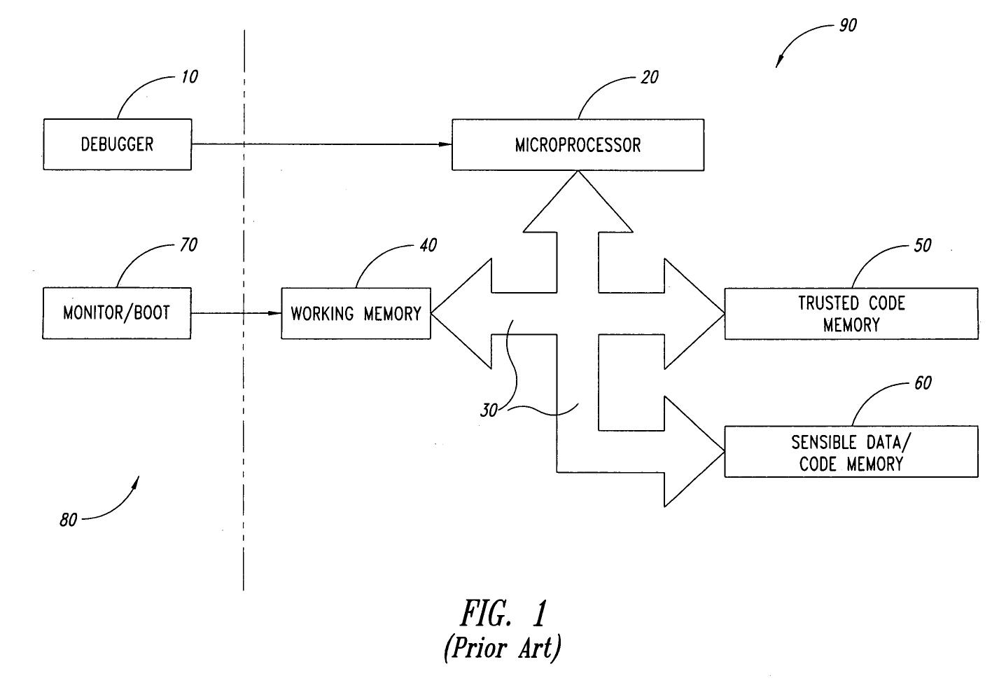

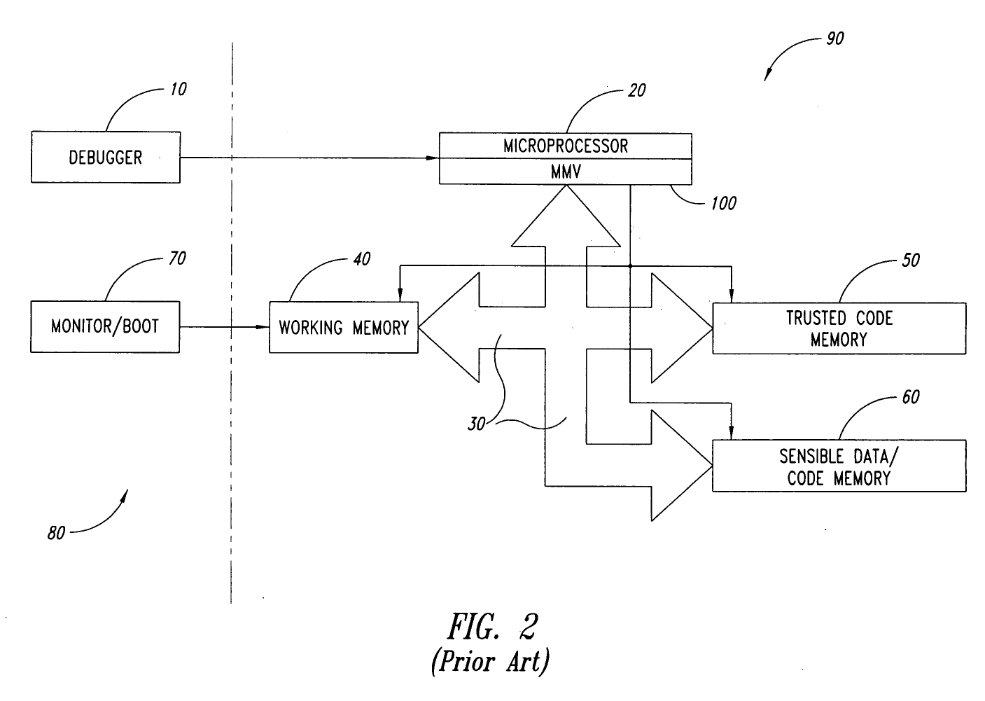

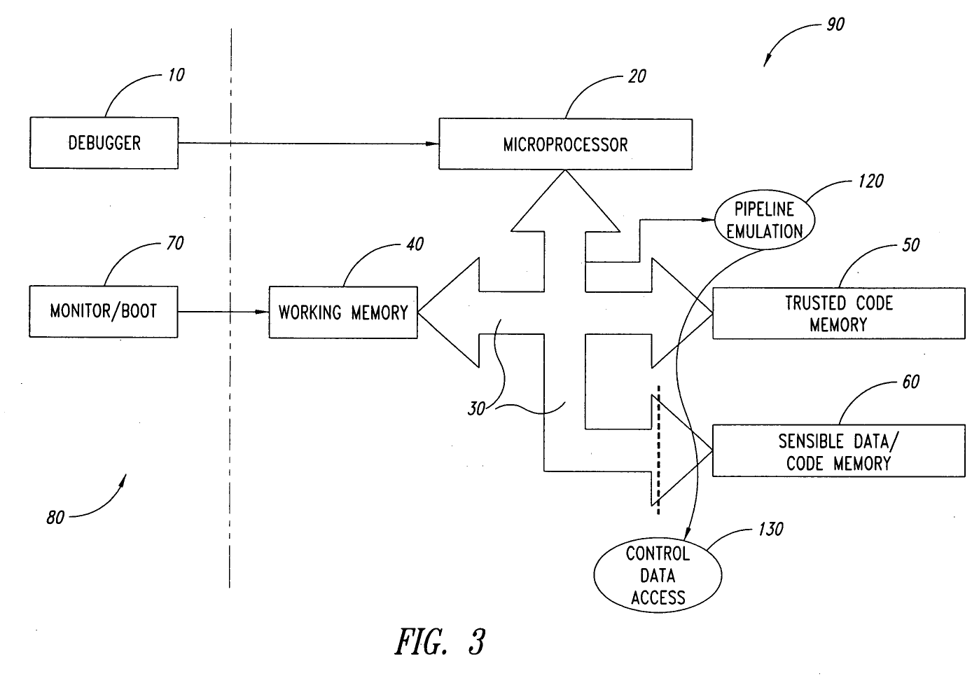

An example of controlled access according to the solution described herein is shown in FIG. 3, wherein blocks identical or equivalent to those already described in connection with FIGS. 1 and 2 are designated with the same reference numbers.

Specifically, in FIG. 3 the microprocessor 20 is an ARM7 microprocessor designated 110, and a pipeline emulation block 120 is added in order to perform a control data access function 130.

The solution described herein is adapted to be implemented e.g., in the ST30 product family which is based on the RISC (Reduced Instruction Set Computer) processor ARM7TDMI.

The arrangement described herein can be easily configured in order to mark all the instructions with a field describing the origin of the code being executed, thus enabling data access only from authorized code. This solution employs only a minimum amount of additional logic as described in the following.

A specific protection arrangement can be implemented through a model of the ARM7TDMI pipeline a description of which can be found at the web site address hftp://www.arm.com/pdfs/DDI0210B_{—}7TDMI_R4.pdf, wherein the possibility exists of predicting what instruction is currently in the EXECUTE phase of the pipeline.

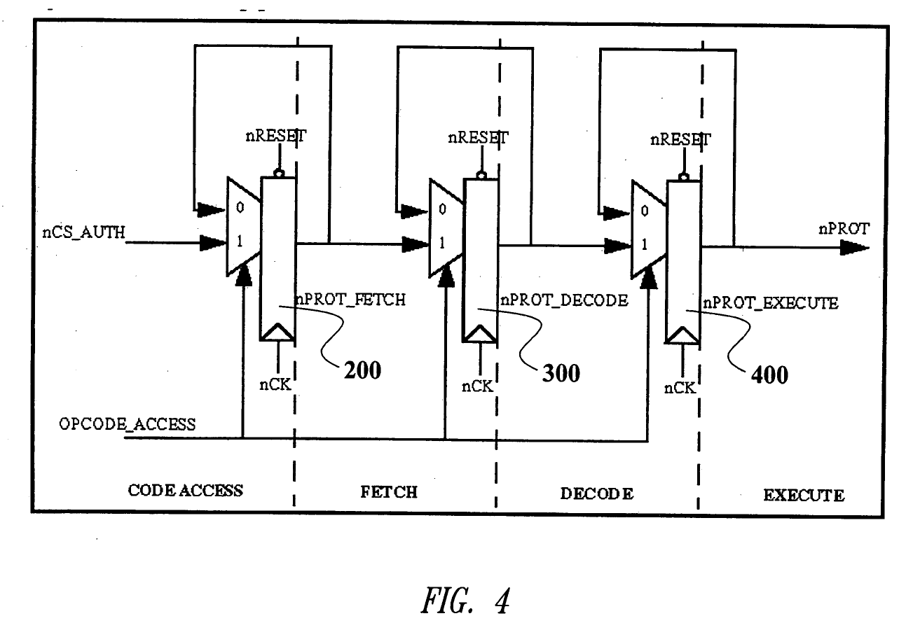

By resorting to that arrangement a bit is associated with all the instructions currently in the pipeline (at FETCH, DECODE and EXECUTE phase) in the form of a bit configured to mark if the instruction in question has been executed from an authorized memory area or not. The additional bit is saved at a dedicated location such as a dedicated flip-flop, and there is one flip-flop for each pipeline phase (see e.g., the flip-flops 200, 300, and 400 shown in FIG. 4).

This arrangement uses and emulates the ARM7TDMI core. In particular, the following ARM7TDMI signals, synchronous with the ARM7TDMI core clock, are used:

nMRQ is the memory request signal: 0=memory request, 1=idle;

nOPC is the memory access type signal: 0=opcode, 1=data;

nWAIT is a temporization signal for the management of memories with several wait states.

When a memory cannot provide a data within the end of the cycle, it asserts the signal nWAIT low in order to stall the processor, until the data is available at the memory output.

The additional bit is shifted from one flip-flop to the next one each time a valid OPCODE fetch is performed by the ARM7TDMI processor (nMRQ=0, nOPC=0 and nWAIT=1 at clock falling edge).

FIG. 4 shows a possible way of generating an nPROT signal for controlling the access to a protected memory area such as the area 60. An OPCODE_ACCESS signal is set to the high value when a valid OPCODE operation is done by the microprocessor (nMRQ=0, nOPC=0 and nWAIT=1 at clock falling edge in the case of ARM7TDMI).

Every time the OPCODE_ACCESS is high, a new instruction is processed by the microprocessor ARM7TDMI, and the previous instruction is pushed ahead in the pipeline. In the same way, the three flip-flops nPROT_FETCH, nPROT_DECODE, and nPROT_EXECUTE are updated, pushing ahead the nPROT information associated with the pipeline instruction.

Specifically:

nPROT_FETCH is updated with the type of access ‘0’ when an authorized memory is accessed, with the type of access ‘1’ otherwise;

nPROT_DECODE is updated with the nPROT_FETCH value, nPROT_EXECUTE (which is an alias for final nPROT signal) is updated with the nPROT_DECODE value.

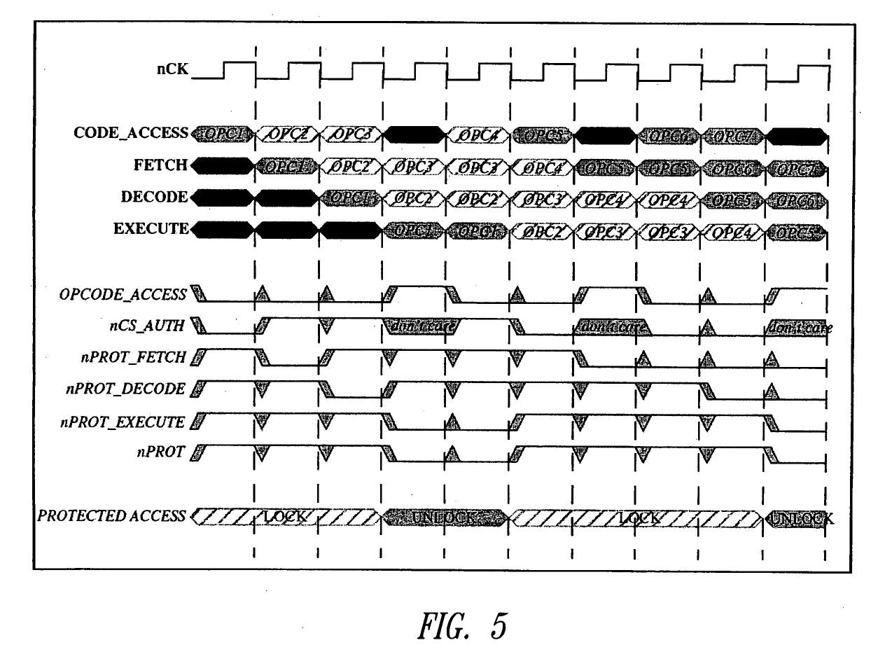

FIG. 5 reports some timing diagram showing the status of the protected access depending on the source where the instruction has been fetched.

The first line represents the clock signal.

The first group of signals represent the status of the ARM pipeline:

a first type of instruction (e.g. OPC1, OPC5-7) is an instruction fetched from a memory address which allows protected peripheral accesses,

a second type of instruction (e.g. OPC2-4) is an instruction fetched from a memory address which does not allow protected peripherals accesses, and

a darkened polygon refers to a non-instruction.

The second group of signals represent the status of the nPROT information propagation.

The PROTECTED ACCESS signal reports the status of the peripherals that should be protected:

LOCK means that the peripheral/memory cannot be accessed,

UNLOCK means that the peripheral/memory can be accessed.

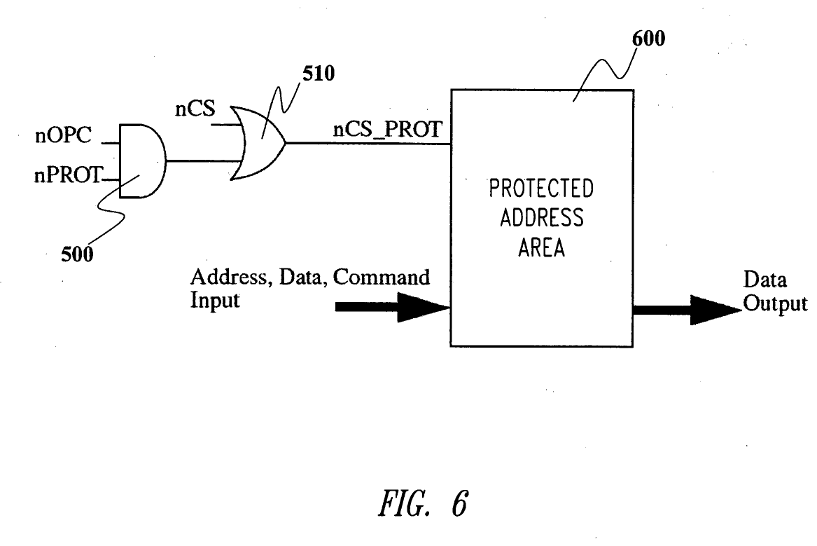

FIG. 6 shows the generation of the selection of the protected area. All signals are active at the low state.

The protected area can be accessed only in the following cases:

processor requests access to fetch code from protected area, and

processor requests access to read/write data from protected area and nPROT is at the low state (code has been fetched from authorized memory)

In case the processor requests access to read/write data from the protected area with nPROT equal to the value 1, the protected area will not be selected. Further action can be taken like returning a dummy data or generating a FAULT (or nABORT in case of ARM7TDMI) signal to the processor.

The additional hardware employed is represented by an AND logic port 500 with receives as input two signals: nOPC and nPROT. The output of the AND port 500 is fed to an OR logic port 510 together with a signal nCS. The output of the OR port 510 is represented by a signal nCS_PROT that enables the operations in a protected address area 600.

Without prejudice to the underlying principles of the invention, the details and the embodiments may vary, also appreciably, with reference to what has been described by way of example only, without departing from the scope of the invention as defined by the annexed claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A method of providing controlled access to a memory area storing code and data, of the method comprising:
providing a processor cooperating with said memory area;
marking instructions processed by said processor with a field indicating an origin of the instructions being executed; and
enabling data access in said memory area only from authorized instructions.

2. The method of claim 1, wherein the providing step includes providing said processor as a RISC processor.

3. The method of claim 1, wherein the providing step includes providing said processor as a processor including a pipeline emulation block, the method further comprising:
implementing said controlled access to said memory area via said pipeline emulation block.

4. The method of claim 3, wherein the marking step includes the step of associating with an instruction currently in said pipeline a bit marking if the instruction in question has been executed from an authorized memory area or not.

5. The method of claim 4, further comprising the step of saving said bit as an additional bit saved at a respective dedicated location.

6. The method of claim 5, where the saving step includes saving said bit as an additional bit saved in a dedicated one of a plurality of flip-flops.

7. The method of claim 6, further comprising providing a respective flip-flop of the plurality of flip-flops for each phase in said pipeline.

8. The method of claim 6, further comprising shifting said additional bit from one to a next one of said plurality of flip-flops each time a valid fetch is performed by said processor.

9. The method of claim 8, further comprising:
every time a new instruction is processed by said processor, pushing a previous instruction ahead in said pipeline; and
updating said plurality of flip-flops by pushing ahead therethrough the bits associated with the pipeline instructions.

10. A system, comprising:
a memory area storing code and data; and
a processor cooperating with said memory area, said processor being configured for marking instructions processed by said processor with a field indicating an origin of the instructions being executed, and enabling data access in said memory area only from authorized instructions.

11. The system of claim 10, wherein said processor is a RISC processor.

12. The system of claim 10, wherein said processor is a processor including a pipeline emulation block, and said controlled access to said memory area is implemented via said pipeline emulation block.

13. The system of claim 12, wherein said processor is configured for associating with an instruction currently in said pipeline a bit marking if the instruction has been executed from an authorized memory area or not.

14. The system of claim 13, further comprising a set of respective dedicated locations for saving said bit as an additional bit.

15. The system of claim 14, wherein the set of dedicated locations includes a plurality of flip-flops for saving said bit as an additional bit.

16. The system of claim 15, wherein the plurality of flip-flops includes a respective flip-flop for each phase in said pipeline.

17. The system of claim 15, wherein said plurality of flip-flops is configured for shifting said additional bit from one to a next one of said plurality of flip-flops each time a valid fetch is performed by said processor.

18. The system of claim 17, wherein said processor is configured for:
every time a new instruction is processed by said processor, pushing a previous instruction ahead in said pipeline; and
updating said plurality of flip-flops by pushing ahead therethrough the bits associated with the pipeline instructions.

19. A computer-readable medium including code portions that cause a computing device to provide a processor with controlled access to a memory area, which stores code and data, by performing a method comprising:
marking instructions processed by said processor with a field indicating an origin of the instructions being executed; and
enabling data access in said memory area only from authorized instructions.

20. The computer-readable medium of claim 19, wherein the processor includes a pipeline emulation block, the method further comprising:
implementing said controlled access to said memory area via said pipeline emulation block.

21. The computer-readable medium of claim 20, wherein the marking step includes the step of associating with an instruction currently in said pipeline a bit marking whether the instruction in question has been executed from an authorized memory area.

22. The computer-readable medium of claim 21, further comprising the step of saving said bit as an additional bit saved at a respective dedicated location.
